(19) United States
(12) Patent Application Publication
(10) Pub. No.: US 2001/0046436 A1
(43) Pub. Date: Nov. 29, 2001

(54) Article transfer apparatus

(75) Inventor: Donald Simson Mahoney, Red Hill Victoria (AU)

Correspondence Address: MICHAEL BEST & FRIEDRICH, LLP, ONE SOUTH PINCKNEY STREET, P O BOX 1806, MADISON, WI, 53701

(73) Assignee: Becfab Equipment Pty Ltd, Dandenong South Victoria (AU)

(21) Appl. No.: 09/867,314

(22) Filed: May 29, 2001

(30) Foreign Application Priority Data
May 29, 2000 (AU) PQ7809

(51) Int. Cl. B66C 1/00

(52) U.S. Cl. 414/796.4; 414/797; 414/797.1; 414/796.9; 414/737

(57) ABSTRACT

A transfer apparatus for articles is provided comprising:

(a) a support; and

(b) an arm, engaging or connecting to the support and movable between a first and second position vertically displaced relative to one another, the arm being rotatable about the support in a substantially vertical plane from a first side of the support to a second side of the support opposite the first side, the arm comprising;

(i) a connector having a releasable attachment for engaging an article, wherein the connector is located distant from the support; and

(ii) a rotation device to rotate the connector relative to the arm to re-orient the article attached to the connector from an attachment position on the first side of the support to a detachment position on the second side of the support.

### FIELD OF THE INVENTION

The invention relates to a transfer apparatus for articles. More particularly, the transfer apparatus is useful for moving and/or stacking articles such as prefabricated building components (such as trusses) or other building components (such as cut timber). It may also be useful in transferring other movable and/or stackable articles (such as plastic sheet, plastic pipe, injection molded plastic articles, sheet and formed metal articles, aluminum extrusions, glass, laminated and composite timber articles, cardboard).

### BACKGROUND OF THE INVENTION

In this specification, where a document, act or item of knowledge is referred to or discussed, this reference or discussion is not an admission that the document, act or item of knowledge or any combination thereof was at the priority date, publicly available; known to the public, part of common general knowledge; or known to be relevant to an attempt to solve any problem with which the i specification is concerned.

Furthermore, whilst the following discussion concerns a transfer apparatus for articles such as trusses and cut timber, it is to be understood that the same principles apply to moving and/or stacking other articles as indicated above.

Traditionally, trusses that are destined for the building industry may be constructed on-site or prefabricated. Prefabricated trusses of standard designs are very popular as they can be mass produced in a jig that can be part of a production line using less technically skilled persons than carpenters. Consequently, considerable time and costs saving can be achieved.

Typically these trusses are up to 15 meters long, 4.2 meters high and weigh up to 210 kg. Because of these dimensions the trusses are difficult to remove from a jig, to stack for storage and transport, or to be moved to other parts of the fabrication site for further processing.

There have been many attempts to automate the fabrication of trusses and the transfer of these trusses.

One attempt is disclosed in U.S. Pat. No. 3,984,010. In this patent a truss is fabricated on a conveyor system of driven rollers. The trusses are stacked vertically by a tilt mechanism that has a pair of arms extending between driven rollers. These arms are rotated about one end to elevate the truss to a substantially vertical position. Whilst placing the trusses in the upright position assists orderly transport, it does not allow easy subsequent processing of a truss that usually requires it to be substantially horizontal. A similar approach is disclosed in U.S. Pat. No. 4,339,117.

Another approach is disclosed in U.S. Pat. No. 4,439,098 that proposes a horizontal truss stacker. A cradle is provided at the end of a truss assembly line as a short continuation of the conveyor. It receives the truss and by vertical movement allows other trusses to also be received and a stack formed. A fork lift is then used to remove the stack after the cradle is partially released.

Another horizontal truss stacker is disclosed in U.S. Pat. No. 5,468,118. In this patent a truss is fabricated on a conveyor system of driven rollers. Support arms, which can be moved vertically, are provided between the driven rollers to lift and support the truss from the rollers. These arms can extend telescopically to move the truss to the side of the conveyor system. The truss is removed from the support arms by it engaging stops on stands to receive the truss.

International patent application no PCT/AU97/00399 discloses an article transfer apparatus including a carriage means to move an article horizontally comprising an elongate transfer member and a conveyor means moveable relative to the elongate transfer member; and support means to move the carriage means vertically. In operation, the carriage means is located under the truss and rises vertically on the support means until the carriage means is in contact with the truss and raises it off the bench. The carriage means then moves horizontally until it is aligned with the deposit site and then descends vertically on the support means until the truss contacts the deposit site and the carriage means is no longer in contact with the truss. If the deposit site is a stack, the carriage means descends vertically until it is just above the stack and then the conveyor means is moved in a first direction whilst synchronously moving the elongated transfer member in an opposite direction at the same rate.

A similar problem to that which exists with truss movement is found in the movement of other articles from machines that are processing or conveying articles, one at a time. For example, the cutting of standard size lengths of timber on a continuous basis from a machine. As the cut timber issues from the cutting machine, it is manually collected or stacked and transported from the site. This is both labor intensive and expensive. Similar problems also exist in the area which processes plastic sheet, plastic pipe, injection molded plastic articles, sheet and formed metal articles, aluminum extrusions, glass, laminated and composite timber articles, and cardboard.

### OBJECT OF THE INVENTION

It is an objective of the present invention to provide an automated transfer apparatus that permits an article to be transferred quickly to a specific location.

### SUMMARY OF THE INVENTION

According to the invention, a transfer apparatus for articles is provided comprising:

(a) a support; and

(b) an arm, engaging or connected to the support and movable between a first and second position vertically displaced relative to one another, the arm being rotatable about the support in a substantially vertical plane from a first side of the support to a second side of the support opposite the first side, the arm comprising

(i) a connector having a releasable attachment for engaging an article, wherein the connector is located distant from the support; and

(ii) a rotation device to rotate the connector relative to the arm to re-orient the article attached to the connector from the attachment position on the first side of the support to the detachment position on the second side of the support.

The present invention further provides a method of using the apparatus of the present invention wherein the rotation of the arm is synchronized so that as the arm rotates about the support in a substantially vertical plane from the first side of the support to the second side of the support, while the connector re-orients the article from the first position to the second position.

Typically the support includes a horizontal base affixed to the ground and a vertical post. The post may be extendable from a first position to a second position, the first and second positions being vertically displaced from one another. For example, the post may be telescopic. Alternatively, the support could be a post affixed to a group and having an arm which is moveable relative to the post from a first position to a second position, the two positions being vertically displaced from one another.

In a particularly preferred embodiment, the support includes a horizontal, elongate base affixed to the ground, having a vertical post adjacent either end of the elongate base.

Typically, where the support includes two vertical posts, each post has an arm comprising a connector and rotation device.

The connector chosen depends upon the articles to be transferred. Typically, the connector has an electric magnet as its attachment if the article contains metal. Alternatively, the connector may include a vacuum, pneumatic mechanical, or other gripping mechanism, or combinations thereof. Typically the connector will attach to the article to be transferred when it is in the first position, and will detach from the article when it is in the second position.

Typically, where the support includes two vertical posts, each having an arm comprising a connector and rotation device, the two connectors can be releasably attached to opposite ends of the article to be transferred.

Preferably, the movement of the rotation device and the rotation of the arm(s) are synchronized so that as the arm(s) rotate(s) about the support in a substantially vertical plane from the first side of the support to the second side of the support, while the connector re-orients the article from the first position to the second position.

Preferably, the rotation device is a chain or belt drive such as a chain conveyor.

Typically, a motor is used to move the arm(s). Typically, where the apparatus includes two or more arms, both arms are driven although one may be a parasite arm.

Optimally a single transfer apparatus of the present invention can be adapted to detach the article transferred onto various decks or surfaces. For example the apparatus may be moved to a roller conveyor, to an angled live deck, to a horizontal live deck

The transfer apparatus of the present invention additionally provides the advantages of saving time and money as compared with truss lifting apparatus of the prior art. By avoiding manual lifting of heavy trusses worker fatigue, and the possibility of worker injury is reduced.

### DESCRIPTION OF THE DRAWINGS

The invention will now be further explained and illustrated by reference to the accompanying drawings in which:

FIG. 1 is a cross-sectional, side view of one embodiment of a transfer apparatus according to the invention;

FIG. 2 is a cross-sectional, side view of the apparatus in FIG. 1 picking up an article from a first position;

FIG. 3 is a cross-sectional, side view of the apparatus in FIG. 1 transferring the article to a second position.

FIG. 4 is a perspective view of a further embodiment of the transfer apparatus of the present invention, showing the arm in 5 different positions as it moves in the direction of the arrows.

FIGS. 5a, 5b and 5c are side views of the apparatus of FIG. 4, showing unloading of trusses to three different surfaces.

FIG. 6a, 6b and 6c show different views of the apparatus of FIG. 4 minus the truss.

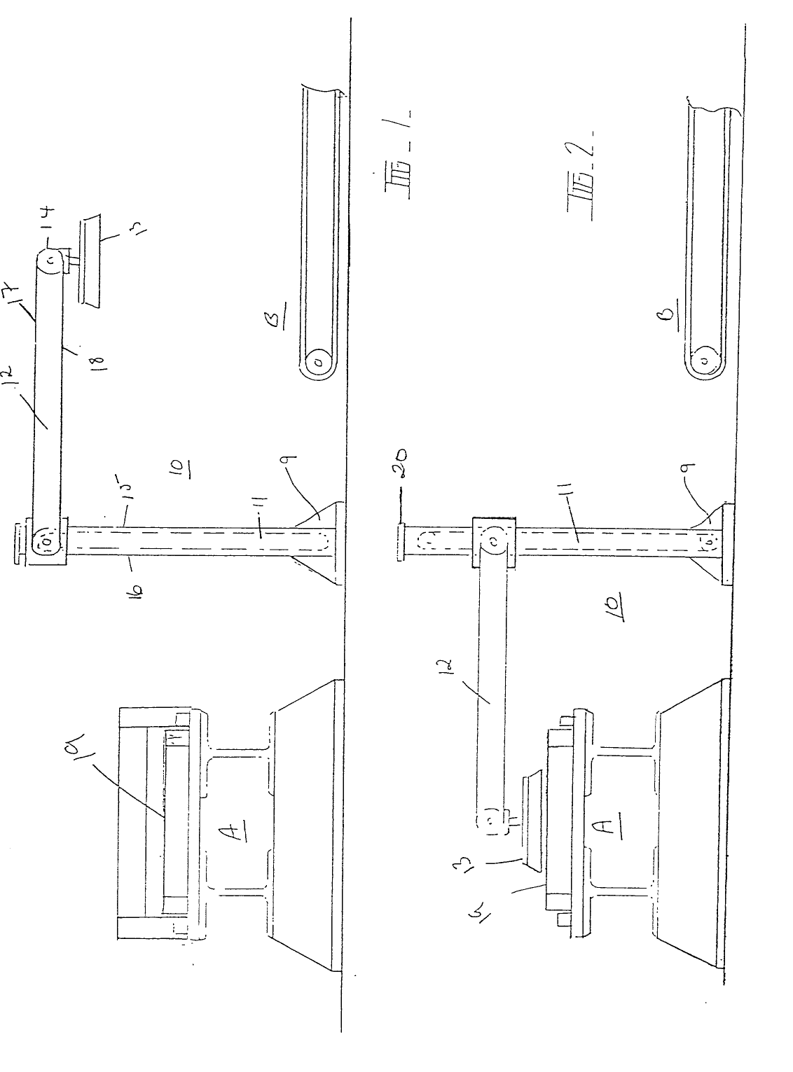

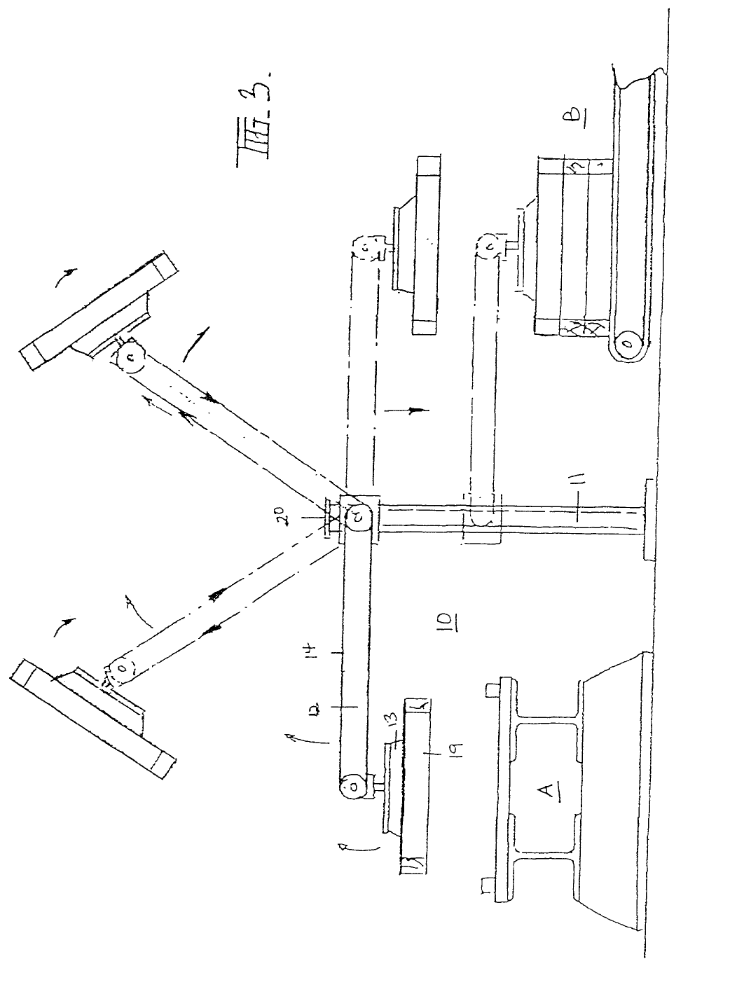

FIGS. 1, 2 and 3 depict one embodiment of the article transfer apparatus 10 of the present invention, comprising a support having a base 9 and a vertical post 11 and an arm 12. The arm 12 has a connector 13 and a rotation device 14 which moves relative to arm 12. The connector 13 is an electric magnet. The rotation device 14 is a chain conveyor. The arm 12 is movable vertically on the post 11 and can rotate in a vertical plane from side 15 to side 16 of the post 11 and vice versa. The rotation device 14 moves connector 13 from side 17 of arm 12 to side 18 and vice versa.

In operation, arm 12 moves along the post 11 until connector 13 engages article 19 at location A. Arm 12 then moves vertically upward along support 11 until it is adjacent the top 20 of the post 11. Arm 12 then rotates in a vertical plane from side 16 to side 15 (as shown in FIG. 3) until it is positioned over location B. While arm 12 is rotating in the vertical plane, rotation device 14 is moving connector 13 from side 17 to side 18 of arm 12 (as shown by the arrows in FIG. 3). As a result, when arm 12 is lowered towards location B, article 19 can be released at location B. This operation can be repeated to form a stack of articles at location B as shown in FIG. 3.

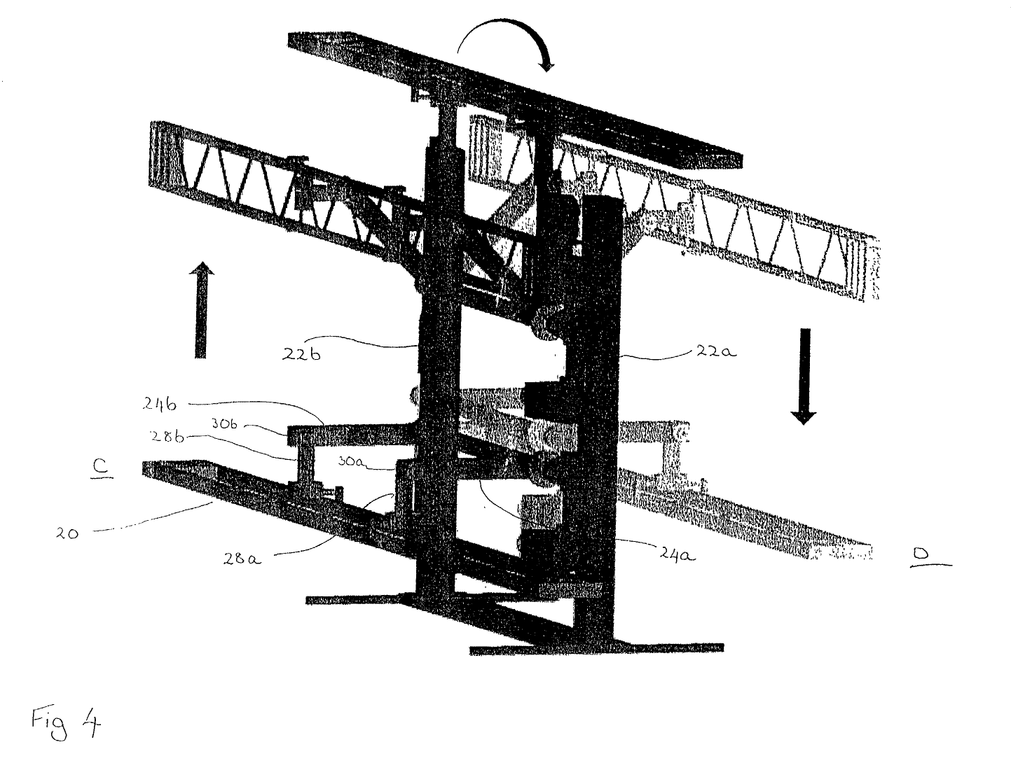

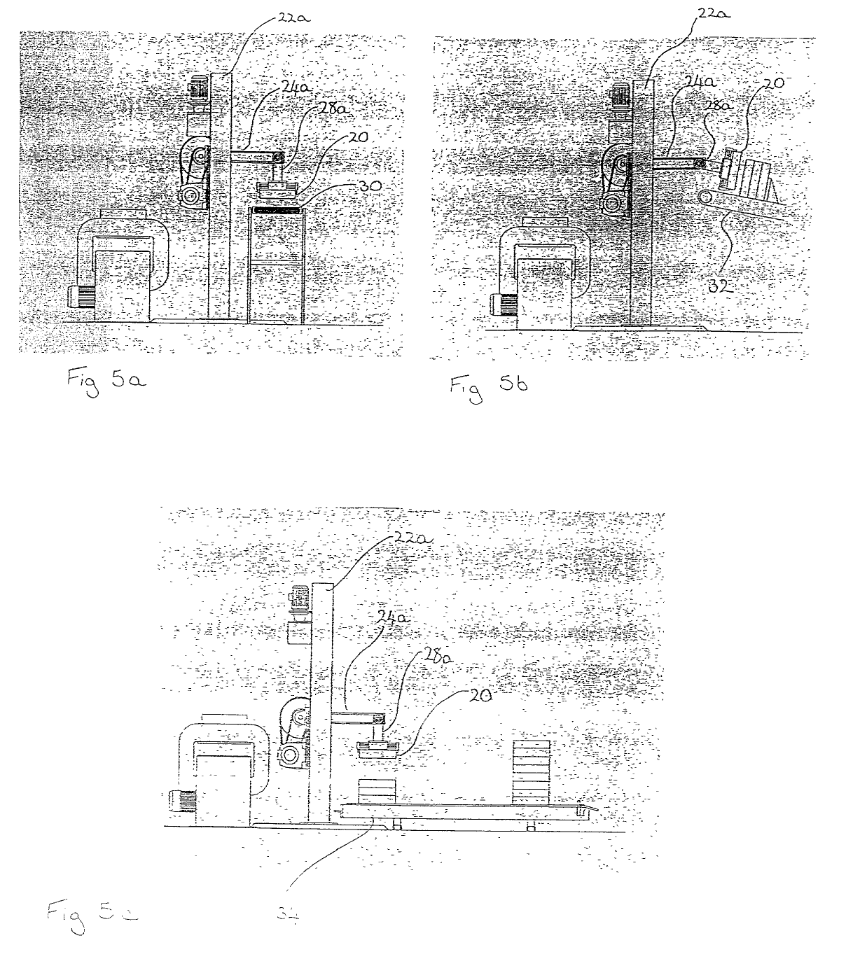

FIG. 4 is a perspective view of a further embodiment of the transfer apparatus of the present invention wherein the support includes two vertical posts 22a, 22b. Each post 22a, 22b has an arm 24a, 24b. The arms 24a, 24b have connectors 28a, 28b and rotation devices 30a, 30b which move relative to the arms 24a, 24b. The connectors 28a, 28b are mechanical gripping devices. In operation, the arms 24a, 24b move along their respective posts 22a, 22b until the connectors 28a, 28b engage the truss 20 at location C. The arms 24a, 24b then move vertically upward along the posts 22a, 22b until they are adjacent the top of their respective posts 22a, 22b. The arms 24a, 24b then rotate in a vertical plane from one side of the posts 22a, 22b (as shown in FIG. 4) until they are positioned over location C. While the arms 24a, 24b rotate in the vertical plane, rotation devices 30a, 30b are moving the connectors 28a, 28b from one side of the arms 24a, 24b to the other side of the arms (in the direction of the arrows in FIG. 4). As a result, when the arms 24a, 24b are lowered towards location D, article 20 can be released at location D.

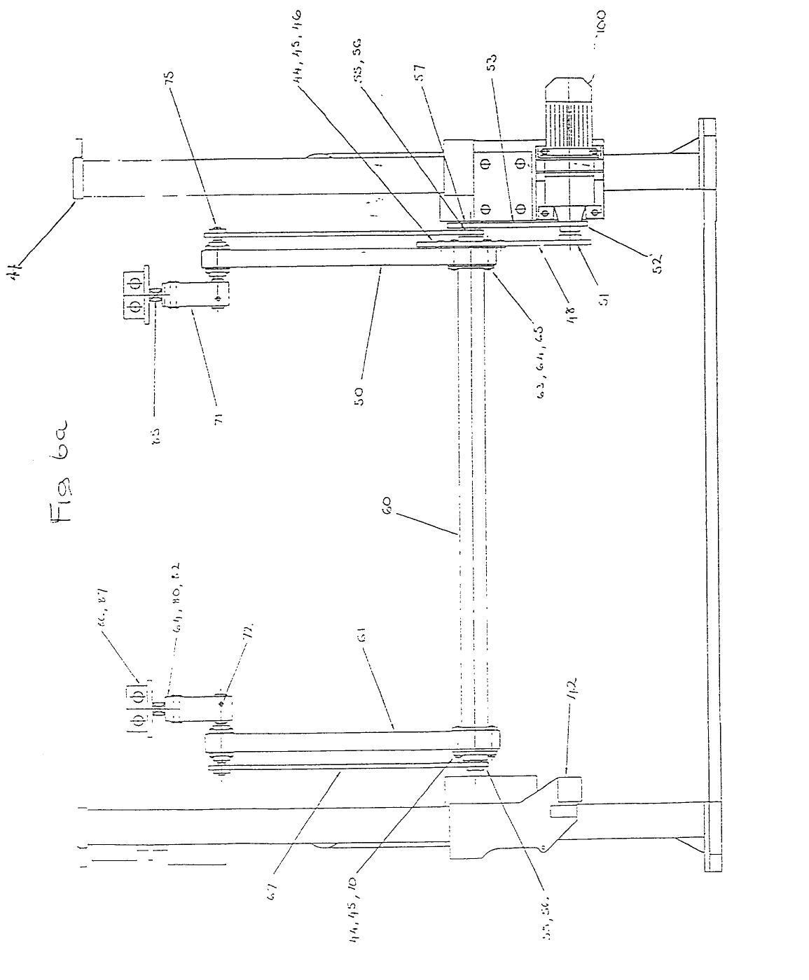

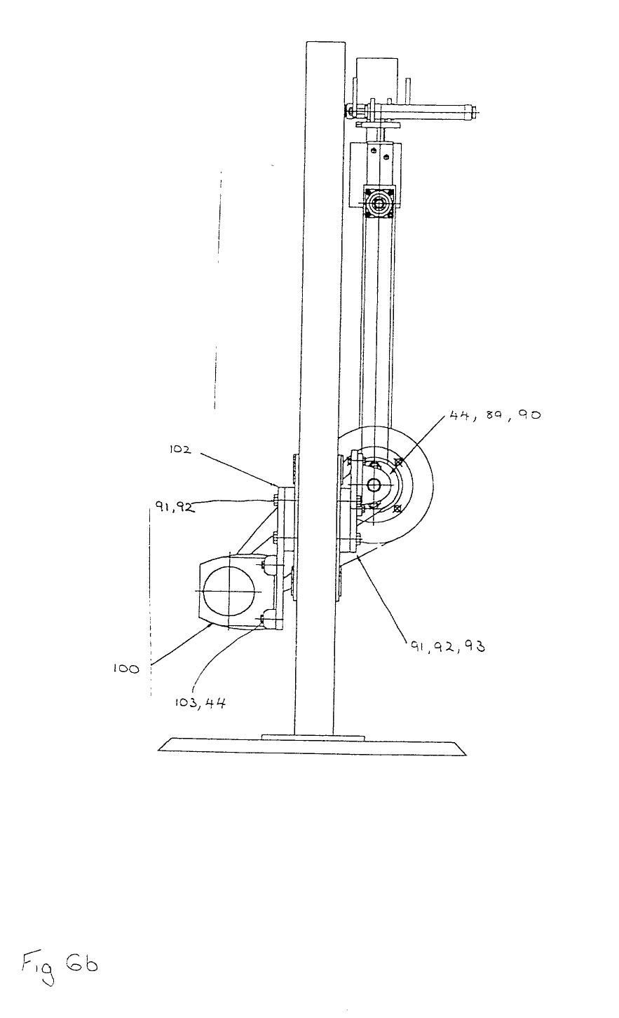

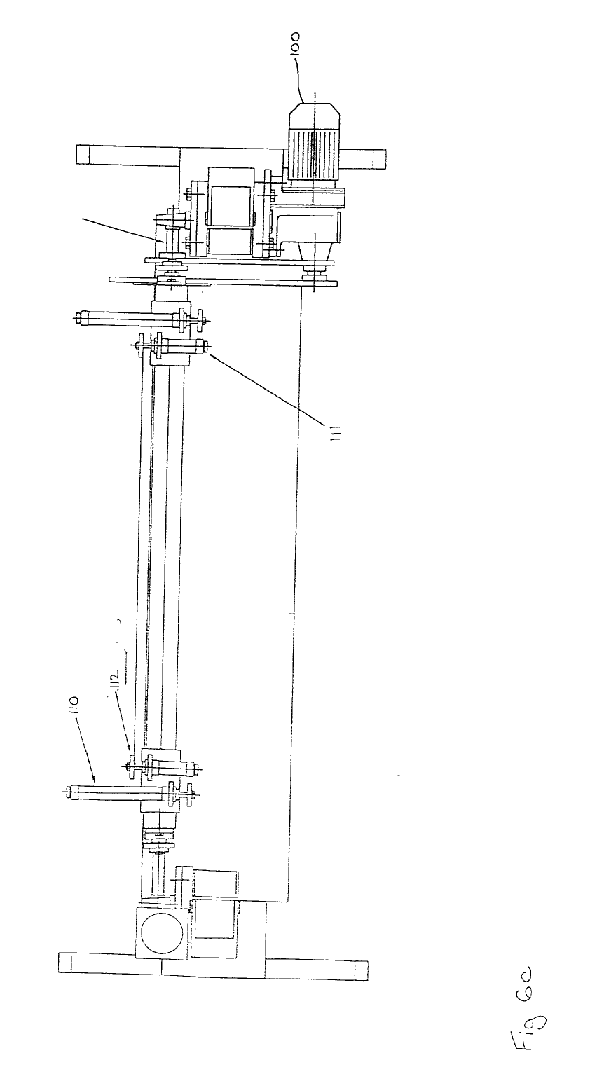

FIG. 5 is a side view of the apparatus of FIG. 4, showing unloading of a truss. In FIG. 5a, the truss is unloaded to a roller conveyor 32. In Figure Sb, the truss is unloaded horizontally onto an angled live deck 32. In FIG. 5c the truss is unloaded vertically to a live deck 34.

FIG. 6a shows a front view of the apparatus of FIG. 4 minus the truss. The apparatus includes a support 41 comprising a hoist with hoist mods 42. A spring washer 44, hexagonal head screw 45 and sprocket 46 combination locate one end of a chain or belt drive 48 to the driven arm 50, the other end of the chain 48 being connected by two other sprockets 51,52 to a second chain or belt drive 53. A key 55 and sprocket 56 combination is located at either end of the torque tube 60, the end closest the motor having a further sprocket 57. Either end of the torque tube 60 is attached to the driven arm 50 and the parasite arm 61 by a hexagonal head screw 63, spring washer 64 and hexagonal nut 65 combination. The parasite arm 61 is attached to the torque tube 60 by a spring washer 44, hexagonal head screw 45 and bearing 70 combination. A drive mechanism 67 is located adjacent the parasite arm 61. At the free end of both the parasite arm 61 and the driven arm 50 is a gripper arm 71 which can articulate about a pivot pin 75. The pivot pin 75 passes through the free end of the arm and one end of the gripper arm 71, held in place by the roll pin 72. The driven arm 50 and the gripper arm 71 can rotate independently. By virtue of a sequence of different sized sprockets they can be driven by the same motor yet operate in a ratio of, for example, 2:1. The free end of each gripper arm 71 includes a gripper mounting bracket 80, held in place by a spring washer 64 and hexagonal head screw 82. A compression spring 85 is located intermediate to the gripper mounting bracket 80 and the gripper mount 86, attached to the spring by a hexagonal nut 87.

Using this arrangement the driven arm 50 can be rotated 180° while the gripper arm 71 is free to rotate up to a further 180° about the end of the driven arm so that a load such as a truss can be readily oriented downwards ready for stacking or loading onto a surface.

FIG. 6b is a side view of the apparatus of FIG. 4 showing on one side of the hoist, the spring washer 44, bearing 89 and hexagonal head bolt 90 combination, and the hexagonal head bolt 91, spring washer and bearing mounting plate 93. On the other side of the hoist one can clearly see the electric motor 100 held on the motor mounting plate 102 by a hexagonal head bolt 103 and spring washer 44. The motor mounting plate 102 is attached to the hoist by a hexagonal head bolt 91 and spring washer 92.

FIG. 6c is a view vertically downwards on the apparatus of FIG. 4. In this view one can see the first festo cylinder (DSW ø50×260 stroke) 110 and second festo cylinder (DSW ø50×40 stroke) 111 and cylinder grip 112 on either gripper mount 86. The main shaft can also be seen 115.

The word ‘comprising’ and forms of the word ‘comprising’ as used in this description does not limit the invention claimed to exclude any variations or additions.

Modifications and improvements to the invention will be readily apparent to those skilled in the art. Such modifications and improvements are intended to be within the scope of this invention.

The claims defining the invention are as follows:

1. A transfer apparatus for articles is provided comprising:
(a) a support; and
(b) an arm, engaging or connecting to the support and movable between a first and second position vertically displaced relative to one another, the arm being rotatable about the support in a substantially vertical plane from a first side of the support to a second side of the support opposite the first side, the arm comprising;
(i) a connector having a releasable attachment for engaging an article, wherein the connector is located distant from the support; and
(ii) a rotation device to rotate the connector relative to the arm to re-orient the article attached to the connector from an attachment position on the first side of the support to a detachment position on the second side of the support.

2. An apparatus according to claim 1 wherein the support includes a post which is extendable from a first position to a second position, the first and second positions being vertically displaced from one another, the arm engaging or connecting to the post.

3. An apparatus according to claim 1 wherein the support includes a post affixed to a group wherein the arm engages or is connected to the post.

4. An apparatus according to any of the preceding claims wherein the connector is chosen from the group comprising electric magnets, a vacuum connector, pneumatic connector, mechanical connector, or combinations thereof.

5. An apparatus according to any of the preceding claims wherein the rotation device is a chain or belt drive and the arm is moved by a motor.

6. A transfer apparatus for articles is provided comprising:
(a) a support having at least two vertical posts; and
(b) at least two arms, each arm separately engaging or separately connected to a post and movable between a first and second position vertically displaced relative to one another, each arm being rotatable about its post in a substantially vertical plane from a first side of its post to a second side of its post opposite the first side, each arm comprising
(i) a connector having a releasable attachment for engaging an article, wherein the connector is located distant from the post to which the arm engages or connects; and
(ii) a rotation device to rotate the connector relative to the arm to re-orient the article attached to the connector from an attachment position on the first side of the post to a detachment position on the second side of the post.

7. An apparatus according to claim 6 wherein the support additionally includes a horizontal, elongate base affixed to the ground, the posts being locate adjacent either end of the elongate base.

8. An apparatus according to claim 6 or 7 wherein the posts are extendable from a first position to a second position, the first and second positions being vertically displaced from one another.

9. An apparatus according to claim 6 or 7 wherein the posts are affixed to a group.

10. An apparatus according to claim 6 wherein the connector is chosen from the group comprising electric magnets, a vacuum connector, pneumatic connector, mechanical connector, or combinations thereof.

11. An apparatus according to claim 6 wherein the rotation device is a chain or belt drive and the arms are moved by a motor.

12. An apparatus according to claim 6 having one driven arm and one parasite arm, motive force for both arms being provided by the same motor.

13. An apparatus according to claim 6 or claim 12 wherein the arms rotate independently of the rotation of their connector.

14. A method of moving a transfer apparatus for articles, the apparatus comprising:
(a) a support; and
(b) an arm, engaging or connected to the support and movable between a first and second position vertically displaced relative to one another, the arm being rotatable about the support in a substantially vertical plane from a first side of the support to a second side of the support opposite the first side, the arm comprising
(i) a connector having a releasable attachment for engaging an article, wherein the connector is located distant from the support; and
(ii) a rotation device to rotate the connector relative to the arm to re-orient the article attached to the connector from an attachment position on the first side of the support to an detachment position on the second side of the support
wherein the rotation of the arm is synchronized so that as the arm rotates about the support in a substantially vertical plane from the first side of the support to the second side of the support, while the connector re-orients the article from the first position to the second position.

15. A method according to claim 14 wherein when the article is in the second position, the connectors detach from the article, delivering the article to a roller conveyor, an angled live deck or a horizontal live deck

16. A method according to claim 14 or 15 wherein the arm rotates independently of the connector.

17. A method of moving a transfer apparatus for articles, the apparatus comprising:
(a) a support having at least two vertical posts; and
(b) at least two arms, each arm separately engaging or separately connected to a post and movable between a first and second position vertically displaced relative to one another, each arm being rotatable about its post in a substantially vertical plane from a first side of its post to a second side of its post opposite the first side, each arm comprising
(i) a connector having a releasable attachment for engaging an article, wherein the connector is located distant from the post to which the arm engages or connects; and
(ii) a rotation device to rotate the connector relative to the arm to re-orient the article attached to the connector from an attachment position on the first side of the post to a detachment position on the second side of the post.
wherein rotation of at least two of the arms is synchronized so that as the arms rotate about the support in a substantially vertical plane from the first side of the supports to the second side of the supports, while the connector re-orients the article from the first position to the second position.

18. A method according to claim 17 wherein when the article is in the second position, the connectors detach from the article, delivering the article to a roller conveyor, an angled live deck or a horizontal live deck

19. A method according to claim 17 or 18 wherein each arm rotates independently of its connector.

20. A method according to claim 16 wherein at least one of the arms is a driven arm and at least one of the arms is a parasite arm.

21. A method according to claim 16 wherein the motive force for both arms is provided by the same motor.
